(19) United States
(12) Patent Application Publication
(10) Pub. No.: US 2017/0140720 A1
(43) Pub. Date: May 18, 2017

(54) SOURCE DRIVE AND LCD DEVICE

(71) Applicants: SHENZHEN CHINA STAR OPTOELECTRONICS TECHNOLOGY CO., LTD., Guangdong (CN); WUHAN CHINA STAR OPTOELECTRONICS TECHNOLOGY CO., LTD., Wuhan, Hubei (CN)

(72) Inventors: Chunpeng GUO, Guangdong (CN); Jiehui QIN, Guangdong (CN); Zhenzhou XING, Guangdong (CN)

(21) Appl. No.: 14/651,337

(22) PCT Filed: May 13, 2015
(86) PCT No.: PCT/CN2015/078822

§ 371 Date: Jun. 11, 2015

(30) Foreign Application Priority Data
Apr. 15, 2015 (CN) 201510176329.8

(51) Int. Cl. G09G 3/36; G02F 1/1368

(52) U.S. Cl. CPC G09G 3/3614; G09G 3/3688; G09G 3/3696; G02F 1/1368; G09G 2320/0276; G09G 2310/0286; G09G 2310/08; G09G 2310/0291

(57) ABSTRACT

A source drive including a bidirectional shift register and a plurality of data channels, each of which includes a data register and a DAC, and connected to the bidirectional shift register and a TFT, is provided, and so is an LCD device. The DAC is shared by two adjacent data channels, for reversing a polarity of a reference voltage according to a line reverse signal which is received from a timing controller, so as to determine the polarities of output voltages of the two adjacent data channels. The source drive has a small size and the cost thereof is low.

### BACKGROUND OF THE INVENTION

1. Field of the Invention

The present invention relates to a field of LCDs (Liquid Crystal Displays), and more specifically to a source drive and an LCD device.

2. Description of the Prior Art

A thin film transistor (TFT) LCD has been the most active branch in the LCD technology field, and one of the most competitive electronic display products, in recent years.

Information displayed by the TFT LCD comes from a processor of a host, therefore an interface to meet the system requirements is required for receiving and generating a scanning signal and an analog voltage. The scanning signal is usually generated by a scanning drive (also called a gate drive), and its main function is applying a trigger gate voltage to a scanning electrode. Grayscale in TFT LCDs is implemented by the analog voltage which is generated by a data drive (also called a source drive). The grayscale voltage of a pixel is changed by variation of an output signal voltage, and further determines the grayscale of the pixel.

Between the two, the source drive is more complex, and needs to support different functions, therefore, the size of the source drive is bigger, and the cost is higher.

### SUMMARY OF THE INVENTION

To overcome the above-mentioned disadvantages, the present invention provides a source drive and LCD device, for resolving the problems of the source drive with bigger size and high cost.

The technical scheme of the present invention is illustrated hereunder.

A source drive comprises a bidirectional shift register and a plurality of data channels, wherein:
the bidirectional shift register is connected to a timing controller, for receiving a clock signal and a synchronous signal therefrom to control on-off logic states of two adjacent data channels in sequence; and
each of the data channels has one end connected to the bidirectional shift register and the other end connected to a TFT, for outputting an analog voltage to the TFT, and each of data channels comprises: a data register, a Digital to Analog Converter (DAC), and a buffer amplifier;
wherein the DAC is shared by the two adjacent data channels, and the DAC reverses a polarity of a reference voltage by receiving a line reverse signal from the timing controller, to determine polarities of output voltages of the two adjacent data channels, the DAC is further used for converting a digital signal into an analog voltage for driving a pixel, wherein the DAC comprises:
a reverse inputting end, connected to the timing controller, for receiving the line reverse signal;
a signal inputting end, connected to two data registers in the two adjacent data channels, for receiving the digital signal; and
a voltage outputting end, connected to two buffer amplifiers in the two adjacent data channels, for outputting the analog voltage.

Preferably, the source drive further comprises:
a voltage module, for providing a Gamma correction reference voltage; and
a polarity reverse control module, for providing a reverse signal for controlling reversal of the polarity, and determine a polarity of the Gamma correction reference voltage.

Preferably, the polarity reverse control module receives the clock signal and generates a reverse signal in each clock cycle.

Preferably, each of the data channels further comprises a level shifter, which is connected between the data register and the DAC, for amplifying voltage of the digital signal.

Preferably, the data register is connected to the bidirectional shift register, the level shifter, and the timing controller, for response the clock signal and storing the digital signals one by one.

Preferably, the buffer amplifier is connected between the DAC and the TFT, for amplifying the analog voltage to enhance the driving capability of the digital signal.

Preferably, the data register comprises at least two latches.

The technical scheme of the present invention is illustrated hereunder.

An LCD device, comprising a source drive, wherein the source drive comprises:
a bidirectional shift register connected to a timing controller; and
a plurality of data channels, each of the data channels having one end connected to the bidirectional shift register and the other end connected to a TFT, for outputting an analog voltage to the TFT, and each of the data channels comprises: a data register and a DAC;
wherein the DAC is shared by the two adjacent data channels, and the DAC reverses a polarity of a reference voltage by receiving a line reverse signal from the timing controller, to determine polarities of output voltage of the two adjacent data channels.

Preferably, the data channel further comprises: a buffer amplifier;
the DAC is used for converting a digital signal into an analog voltage for driving a pixel; wherein the DAC comprises:
a reverse inputting end connected to the timing controller, for receiving the line reverse signal;
a signal inputting end connected to two data registers in the two adjacent data channels, for receiving the digital signal; and
a voltage outputting end, connected to two buffer amplifiers in the two adjacent data channels, for outputting the analog voltage.

Preferably, the source drive further comprises:
a voltage module, for providing a Gamma correction reference voltage; and
a polarity reverse control module, for providing a reverse signal for controlling a reversal of the polarity, and determine a polarity of the Gamma correction reference voltage.

Preferably, the polarity reverse control module receives the clock signal, and generates a reverse signal in each clock cycle.

Preferably, the data channel further comprises a level shifter, which is connected between the data register and the DAC, for amplifying the voltage of the digital signal.

Preferably, the data register is connected to the bidirectional shift register, the level shifter, and the timing controller, for responding to the dock signal and storing the digital signals one by one.

Preferably, the buffer amplifier is connected between the DAC and the TFT, for amplifying the analog voltage to enhance the driving capability of the digital signal.

Preferably, the bidirectional shift register connects to a timing controller, for receiving the clock signal and the synchronous signal therefrom to control on-off logic states of two adjacent data channels in sequence.

Compared to the prior art, the source drive and LCD device in the present invention reduces the number of electronic lines in the data channel, which is not only reduces the size and cost according to sharing of the DAC.

### BRIEF DESCRIPTION OF THE DRAWINGS

In order to describe the technical scheme in the implementation more clearly, the drawings bellow will be introduced in brief. The drawings in the description show just some of the embodiments, for a person of ordinary skill in the art, it is easy to acquire other drawings based on the following drawings without any creative labor.

FIG. 1 is a schematic diagram showing a source drive according to the first embodiment of the present invention;

FIG. 2 is a circuit diagram showing the source drive according to the first embodiment of the present invention;

FIG. 3 is a flow chart showing a source driving method according to of the second embodiment of the present invention; and

FIG. 4 is a circuit diagram of an LCD device according to the third embodiment of the present invention.

### DETAILED DESCRIPTION OF THE PREFERRED EMBODIMENTS

Please refer to the drawings, in which the same component symbols represent the same components. The following description is based on the specific illustrated embodiments of the present invention, which should not be constructed as limitations to the present invention.

### Embodiment One

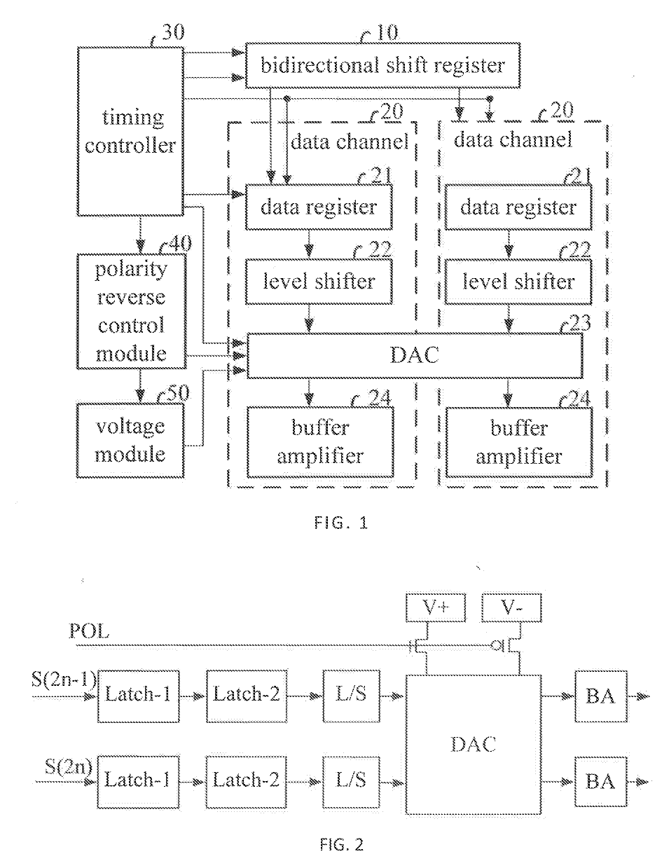

Please refer to FIG. 1, which shows a schematic diagram of a source drive according to a preferred embodiment of the present invention. The source drive comprises a bidirectional shift register 10, a plurality of data channels 20 that connected to the bidirectional shift register 10, a timing controller 30, a polarity reverse control module 40, and a voltage module 50.

The bidirectional shift register 10 is used for controlling on-off logic states of two adjacent data channels 20.

It should be understood that the bidirectional shift register 10 acts in each clock cycle, so as to transmit a logical state from an inputting end to an outputting end. Before each frame time started, a synchronous signal is sent to a first level shift register and a current state by a second level shift register according to the clock signal, that is outputting the logical states to the corresponding data line one by one in sequence.

It should be understood that the bidirectional shift register 10 has one end connected to the timing controller 30 for receiving the clock signal and synchronous signal and the other end connected to the plurality of data channels 20, to control the on-off logic states of two adjacent data channels 20 in sequence.

The data channel has one end connected to the bidirectional shift register 10 and the other end connected to a TFT (not shown), for outputting an analog voltage to the TFT. The data channel 20 comprises: a data register 21, a level shifter 22, a Digital to Analog Converter (DAC) 23, and a buffer amplifier 24.

The DAC 23 is shared by the two adjacent data channels 20, and the DAC 23 reverses the polarity of the reference voltage by receiving a line reverse signal from the timing controller 30, to determine polarities of output voltages of the two adjacent data channels 20.

It should be understood that the data register 21 connects the bidirectional shift register 10 to the timing controller 30. The data register 21 is used for responding to the clock signal, and storing at least two digital signals in a unit time and outputting the stored digital signals.

Among them, the data register 21 comprises at least two latches. If there are two latches, no more circuit elements are required. If there are more than two latches, the line of duplexers depends on the number of the latches.

The level shifter 22 connects the data register 21 to the DAC 23, for amplifying the voltage of the digital signal, as a switch of the reference voltage.

It should be understood that, in one embodiment, the voltage of the digital signal is +3V, and is amplified to be +21V; or the voltage of the digital signal is −5V, and is amplified to be −20V.

The DAC 23 is used for converting a digital signal into an analog voltage for driving a pixel. The DAC 23 comprises a reverse inputting end, a signal inputting end, and a voltage outputting end. Wherein, the reverse inputting end is connected to the timing controller 30 for receiving the line reverse signal. The signal inputting end is connected to two data registers 21 in the two adjacent data channels 20 for receiving the digital signal. The voltage outputting end is connected to two buffer amplifiers 24 in the two adjacent data channels 20 for outputting the analog voltage.

The DAC 23 is used for receiving the line reverse signal, and then reversing the two adjacent data channels 20.

It should be understood that an electric field applied on the liquid crystal molecules is directional. The direction of the electric field is applied oppositely in different periods, namely “polarity reversal”. The purpose of reversal is used to avoid: (1) a Direct Current (DC) blocking effect of the alignment; (2) the DC residues of portable modules. No more repeat here.

The common reversals in the pixel array comprise: a frame inversion, a line inversion, a column inversion, and a dot inversion. Among them, the line inversion mentions to an interlaced line inversion, and in the present invention, the line inversion further mentions to reverse the adjacent data channel.

The polarity reverse control module 40 is used for generating a reverse signal for controlling reversal of the polarity.

It should be understood that the polarity reverse control module 40 receives the clock signal from the timing controller 30 and generates a reverse signal in each clock cycle.

The voltage module 50 is used for providing a Gamma correction reference voltage. Herein, the polarity of the reference voltage reverses according to the reverse signal.

The buffer amplifier 24 is used to amplify the analog voltage in the DAC 23 to enhance the driving capability of the digital signal, and then transmit the amplified analog voltage to the TFT. Herein, the amplified analog voltage is the pixel grayscale voltage in the TFT.

Please refer to FIG. 2, which shows a circuit diagram of a source drive according to a preferred embodiment of the present invention. The source drive comprises two adjacent data channels, and each of the data channels comprises two latches, a level shifter (L/S), a buffer amplifier (BA), and a digital to analog converter (DAC) shared by the two adjacent data channels. Herein, the DAC receives a polling (POL) signal and a reference voltage (V).

In a common source drive, the DAC covers on more than 60% of the whole circuit area. While sharing one DAC in the two adjacent data channels, the size of the source drive is reduced 30%, and the production cost is also reduced.

### Embodiment Two

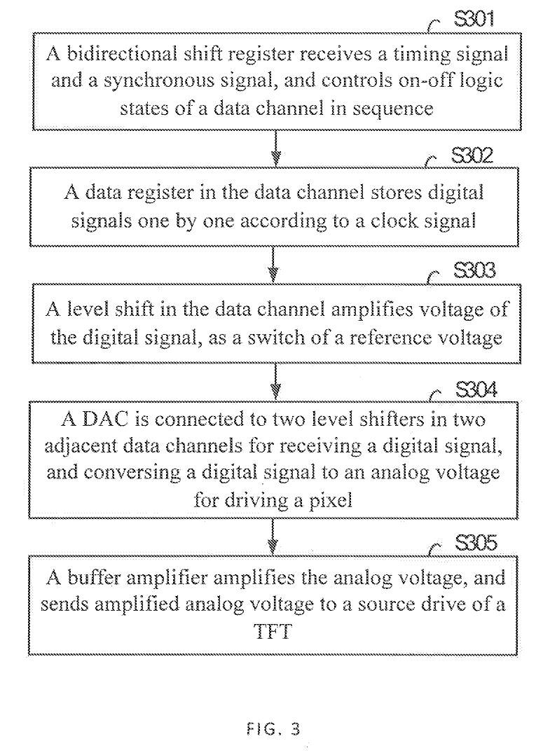

Please refer to FIG. 3, which shows a flow chart of a source driving according to a preferred embodiment of the present invention.

In Step S301, a bidirectional shift register receives a timing signal and a synchronous signal therefrom, and controls on-off logic states of a data channel in sequence.

It should be understood that the bidirectional shift register has one end connected to the timing controller for receiving a clock signal and the synchronous signal, and the other end connected to the plurality of data channels to send a logic state signal.

In Step S302, a data register in the data channel stores digital signals one by one according to the clock signal.

In Step S303, a level shifter in the data channel amplifies a voltage of the digital signal, as a switch of a reference voltage.

In Step S304, a DAC connected to two level shifters in two adjacent data channels for receiving a digital signal converts the digital signal to the analog voltage for driving a pixel.

It should be understood that an inputting end of the DAC is connected to a timing controller for receiving the line reverse signal, and is connected to two data registers in the two adjacent data channels for receiving the digital signal; an outputting end of the DAC is connected to two buffer amplifiers in the two adjacent data channels for outputting the analog voltage.

In Step S305, the buffer amplifier amplifies the analog voltage, and sends the amplified analog voltage to a source drive of a TFT.

In the present invention, the source drive and LCD device in the present invention saves electronic lines of the data channel, which not only reduces the size but also saves the cost according to sharing of the DAC.

In a common source drive, the DAC covers on more than 60% of the whole circuit area. While sharing one DAC in the two adjacent data channels, the size of the source drive is reduced 30%, and the production cost is also reduced.

### Embodiment Three

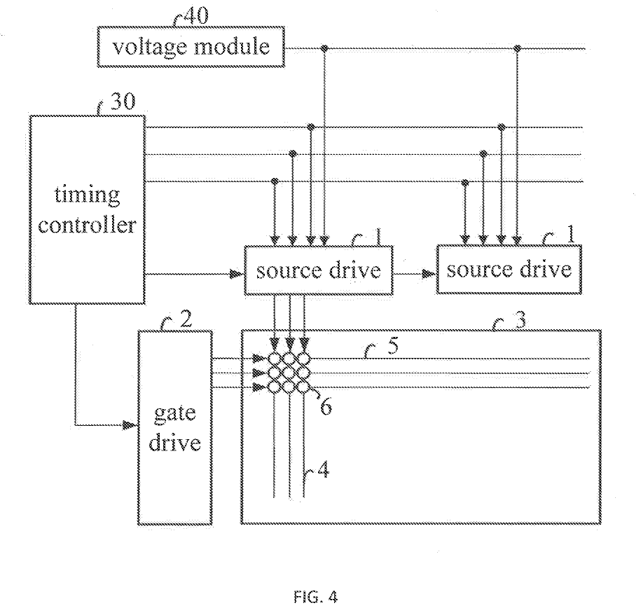

Please refer to FIG. 4, which shows a circuit diagram of an LCD device according to a preferred embodiment of the present invention.

An electronic field is used to control light transmittance of liquid crystal modules when the LCD device shows a picture. Therefore, a LCD device is provided, comprising an LCD panel 3, a source drive 1, and a gate drive 2.

In the LCD panel 3, a plurality of data lines 5 and scanning lines are arranged across each other, and depend on light transmittance of the liquid crystal modules covering on the TFT.

The source drive 1 is connected to a voltage module 50, and receives the clock signal together with the gate drive 2, and sends an analog voltage and a scanning signal to a pixel 6 of the TFT by the data line 4 and the scanning line 5, respectively.

The source drive 1 has one end connected to a display control module, for communication with a CPU and an LCD, and the other end connected to the LCD panel for driving a TFT in the LCD to implement the grayscale. Therefore, the source drive ought to logically process the digital signal and the control signal coming from the host, and after level switching and D/A conversion, output via the buffer amplifier for driving a pixel.

It should be understood that, although the embodiments focus differently, the design idea is consistent. Some ignore parts may relate to the whole specification, and are not repeated herein.

In conclusion, although the present invention has been described with reference to certain preferred and alternative embodiments, they are intended to be exemplary only and do not limit the full scope of the present invention as set forth in the appended claims.

What is claimed is:

1. A source drive, comprising a bidirectional shift register and a plurality of data channels, wherein:
the bidirectional shift register is connected to a timing controller, for receiving a clock signal and a synchronous signal therefrom to control on-off logic states of two adjacent data channels in sequence; and
each of the data channels has one end connected to the bidirectional shift register and the other end connected to a TFT, for outputting an analog voltage to the TFT, and each of the data channels comprises a data register, a Digital to Analog Converter (DAC), and a buffer amplifier;
wherein the DAC is shared by the two adjacent data channels, and the DAC reverses a polarity of a reference voltage by receiving a line reverse signal from the timing controller, to determines the polarities of output voltages of the two adjacent data channels, the DAC is further used for converting a digital signal into an analog voltage for driving a pixel, wherein the DAC comprises:
a reverse inputting end, connected to the timing controller, for receiving the line reverse signal;
a signal inputting end, connected to two data registers in the two adjacent data channels, for receiving the digital signal; and
a voltage outputting end, connected to two buffer amplifiers in the two adjacent data channels, for outputting the analog voltage.

2. The source drive as claimed in claim 1, further comprising:
a voltage module, for providing a Gamma correction reference voltage; and
a polarity reverse control module, for providing a reverse signal for controlling reversal of the polarity, and determine a polarity of the Gamma correction reference voltage.

3. The source drive as claimed in claim 2, wherein the polarity reverse control module receives the clock signal, and generates a reverse signal in each clock cycle.

4. The source drive as claimed in claim 1, wherein the data channel further comprises a level shifter, which is connected between the data register and the DAC, for amplifying a voltage of the digital signal.

5. The source drive as claimed in claim 4, wherein the data register is connected to the bidirectional shift register, the level shifter, and the timing controller, for responding to the clock signal and storing the digital signals one by one.

6. The source drive as claimed in claim 1, wherein the buffer amplifier is connected between the DAC and the TFT, for amplifying the analog voltage to enhance a driving capability of the digital signal.

7. The source drive as claimed in claim 1, wherein the data register comprises at least two latches.

8. An LCD device, comprising a source drive, wherein the source drive comprises:
a bidirectional shift register connected to a timing controller; and
a plurality of data channels, and each of the data channels having one end connected to the bidirectional shift register and the other end connected to a TFT, for outputting an analog voltage to the TFT, and each of the data channels comprises: a data register and a DAC;
wherein the DAC is shared by two adjacent data channels, and the DAC reverses a polarity of a reference voltage by receiving a line reverse signal from the timing controller, to determine polarities of output voltage of the two adjacent data channels.

9. The LCD device as claimed in claim 8, wherein:
each of the data channels further comprises: a buffer amplifier;
the DAC is used for converting a digital signal into an analog voltage for driving a pixel; wherein the DAC comprises:
a reverse inputting end, connected to the timing controller, for receiving a line reverse signal;
a signal inputting end, connected to two data registers in the two adjacent data channels, for receiving the digital signal; and
a voltage outputting end, connected to two buffer amplifiers in the two adjacent data channels, for outputting the analog voltage.

10. The LCD device as claimed in claim 9, wherein the source drive further comprises:
a voltage module for providing a Gamma correction reference voltage; and
a polarity reverse control module for providing a reverse signal for controlling reversal of the polarity, and determine a polarity of the Gamma correction reference voltage.

11. The LCD device as claimed in claim 10, wherein the polarity reverse control module receives the clock signal, and generates a reverse signal in each clock cycle.

12. The LCD device as claimed in claim 9, wherein the data channel further comprises a level shifter, which is connected between the data register and the DAC, for amplifying voltage of the digital signal.

13. The LCD device as claimed in claim 12, wherein the data register is connected to the bidirectional shift register, the level shifter, and the timing controller, for responding to the clock signal and storing the digital signals one by one.

14. The LCD device as claimed in claim 9, wherein the buffer amplifier is connected between the DAC and the TFT, for amplifying the analog voltage to enhance a driving capability of the digital signal.

15. The LCD device as claimed in claim 8, wherein the bidirectional shift register is connected to a timing controller, for receiving a clock signal and a synchronous signal therefrom to control on-off logic states of two adjacent data channels in sequence.
